(19) United States
(12) Patent Application Publication
(10) Pub. No.: US 2007/0066257 A1
(43) Pub. Date: Mar. 22, 2007

(54) Wireless communication system

(75) Inventors: Shigeru Hatakeyama, Tokyo (JP); Shigeru Yamazaki, Tokyo (JP); Hiroki Murayama, Tokyo (JP); Koichi Hirano, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/520,801

(22) Filed: Sep. 14, 2006

(30) Foreign Application Priority Data
Sep. 16, 2005 (JP) 2005-271188

(51) Int. Cl. H04Q 5/22

(52) U.S. Cl. 455/208; 340/10.1

(57) ABSTRACT

A wireless communication system includes: wireless IC chips used for identifying objects; a transceiver for transmitting and receiving information to/from the wireless IC chips by radio waves; and a radio wave direction unit for directing the traveling directions of the radio waves from the transceiver toward the wireless IC chips. The radio wave direction unit is arranged such that the radio wave reflecting surface can be developed to face a collection space where the wireless IC chips are collected. A part of the radio waves radiated from the transceiver travels stereoscopically toward the collection space S by an action of the radio wave reflecting surface.

### BACKGROUND OF THE INVENTION

1. Field of the Invention

The present invention relates to a wireless communication system used for managing products in a product distribution process for example.

2. Description of Related Art

In a store like a supermarket, products are arranged on shelves, and in a warehouse of the store or a warehouse in the distribution process, various kinds of products are stored. For these products, it is not enough to only store them. Stocks must be added when they are consumed. Further, the products must be carried out according to orders. In order to manage such products, a wireless communication system has been used.

The wireless communication systems disclosed in Japanese Patent Laid-Open Publication No. 2004-32067 and Japanese Patent Laid-Open Publication No. 2005-109603 are ones in which the RFID technique is applied, including RFID (Radio Frequency IDentification) tags having antenna coils, memories and the like and a reader/writer module which reads information from RFID tags and writes information to RFID tags by using radio waves. The reader/writer module is connected with a host computer which performs information management.

RFID tags are to be attached to products, so they can be attached to the same positions on the products. Products have such a characteristic that they are delivered to clients through distribution processes, and stored in warehouses temporarily. Therefore, when products are stored in a piled-up manner, the products are seldom stored with the attached RFID tags being aligned in the same direction. The RFID tags are in random directions usually.

As for the reader/writer module, it is the actual situation that one reader/writer module typically manages a plurality of RFID tags attached to products and collected in a warehouse, in view of the economical aspect and efficiency.

This kind of wireless communication system uses radio waves of weak power in order to avoid damages on other equipment by the radio waves, and the communication distance is limited to a range of about 30 cm to several meters.

Depending on the storing conditions of the products, the RFID tags may face random directions, so radio waves radiated from a reader/writer may not reach the RFID tags, causing a problem that read/write communications of high reliability cannot be performed.

### SUMMARY OF THE INVENTION

It is therefore an object of the present invention to provide a wireless communication system capable of performing read/write communications of high reliability, even though RFID tags face random directions.

In order to achieve the object, a wireless communication system according to the present invention comprises: wireless IC chips provided to identification objects; a transceiver for transmitting and receiving information to/from the wireless IC chips by radio waves; and a radio wave direction unit for directing traveling directions of the radio waves from the transceiver toward the wireless IC chips. The radio wave direction unit is arranged such that the radio wave reflecting surface can be developed to face a collection space where the wireless IC chips are collected.

According to the present invention, in the traveling directions of radio waves from the transceiver, the wireless IC chips at positions capable of receiving the radio waves directly receive the radio waves directly from the transceiver. However, some wireless IC chips may not be able to receive the radio waves from the transceiver directly due to the storage conditions of the products.

The present invention includes a radio wave direction unit in a space where a plurality of wireless IC chips are collected, and the traveling directions of the radio waves from the transceiver are directed to the wireless IC chips by the radio wave direction unit, so the wireless IC chip receives the radio waves from the transceiver via the radio wave direction unit.

Further, the radio wave direction unit is arranged such that the radio wave reflecting surface can be developed to face the collection space where the wireless IC chips are collected. Therefore, in a state that the radio wave reflecting surface is not developed, that is, in a state of being stored, it will not cause a trouble in conveying articles having wireless IC chips. Further, by developing the radio wave reflecting surface of the radio wave direction unit to face the collection space, read/write communications of high reliability are performed between the transceiver and the wireless IC chips irrespective of the directions of the wireless IC chips.

The radio wave direction unit includes a plurality of reflecting plates specifically, and the radio wave reflecting surface of the radio wave direction unit is formed of a combination of reflecting surfaces of the reflecting plates. Further, the reflecting plates are linked to be able to be developed facing the collection space.

According to this configuration, a plurality of reflecting plates linked to each other are stored in a stacked manner, and the reflecting plates are drawn from the stacked state and developed such that the radio wave reflecting surface formed of the reflecting surfaces of the reflecting plates face the collection space.

Further, the reflecting surfaces of the reflecting plates may face different directions with respect to the transceiver, depending on the developed positions. In such a case, the directions of the reflecting plates may be adjustable.

According to this configuration, radio waves outputted from the transceiver advance stereoscopically toward the wireless IC chips. Further, by adjusting the directions of the reflecting plates, the radio waves advance to the wireless IC chips accurately.

Further, the radio wave direction unit may be so configured that the radio wave reflecting surfaces are developed at a plurality of positions in the collection space. Further, the radio wave direction unit may be so configured that the radio wave reflecting surfaces are developed by being supported by a movable unit. In this case, the movable unit is desirably arranged to be able to evacuate to the outside of the collection space. Further, it is also acceptable that an antenna of the transceiver and the radio wave direction unit are supported by a movable unit. In this case, it is desirable that the movable unit move inside the collection space and is also able to evacuate to the outside of the collection space.

(Effect of the Invention)

As described above, according to the present invention, a radio wave reflecting surface of a radio wave direction unit is arranged so as to be able to be developed facing a collection space where a plurality of wireless IC chips are collected. Therefore, in a stored state of not developing the radio wave reflecting surface, that is, in a state of nonuse, it is possible to prevent the radio wave direction unit from occupying the collection space without reasonable cause.

### BRIEF DESCRIPTION OF THE DRAWINGS

FIG. 1 is a configuration diagram showing a wireless communication system according to an embodiment 1 of the present invention;

FIG. 2 is a side view showing the wireless communication system according to the embodiment 1 of the present invention;

FIG. 3 is a configuration diagram specifically showing a configuration linking a plurality of reflecting plates in the embodiment of the present invention;

FIG. 4 is a configuration diagram showing a wireless communication system according to an embodiment 2 of the present invention;

FIG. 5 is a configuration diagram showing a wireless communication system according to an embodiment 3 of the present invention;

FIG. 6 is a side view showing the wireless communication system according to the embodiment 3 of the present invention; and

FIG. 7 is a configuration diagram showing a wireless communication system according to an embodiment 4 of the present invention.

### DESCRIPTION OF PREFERRED EMBODIMENTS

Hereinafter, embodiments of the present invention will be explained based on the drawings.

A wireless communication system according to an embodiment of the present invention includes, as the basic configuration: wireless IC chips (3) provided to identification objects; a transceiver (1) for transmitting and receiving information to/from the wireless IC chips by radio waves; and a radio wave direction unit (4) for directing the traveling directions of radio waves from the transceiver (1) to the wireless IC chips (3). The radio wave direction unit is arranged such that a radio wave reflecting surface is able to be developed to face a collection space where a plurality of wireless chips are collected.

Next, embodiments of the present invention will be described specifically based on examples in which a plurality of reflecting plates 4 having reflecting surfaces 4a are used as the radio wave direction unit, RFID tags 3 for identifying objects are used as the wireless IC chips, and a reader/writer for managing the RFID tags 3 is used as the transceiver. The RFID tag includes an antenna coil, a memory and the like. The reader/writer 1 has a function of reading information from and writing information to the RFID tags 3 by radio waves, and the reader/writer 1 is adapted to perform transmission and reception of radio waves to/from the RFID tags 3 with the antenna 2 thereof. For the RFID tags and the reader/writer, general purpose ones are used.

(Embodiment 1)

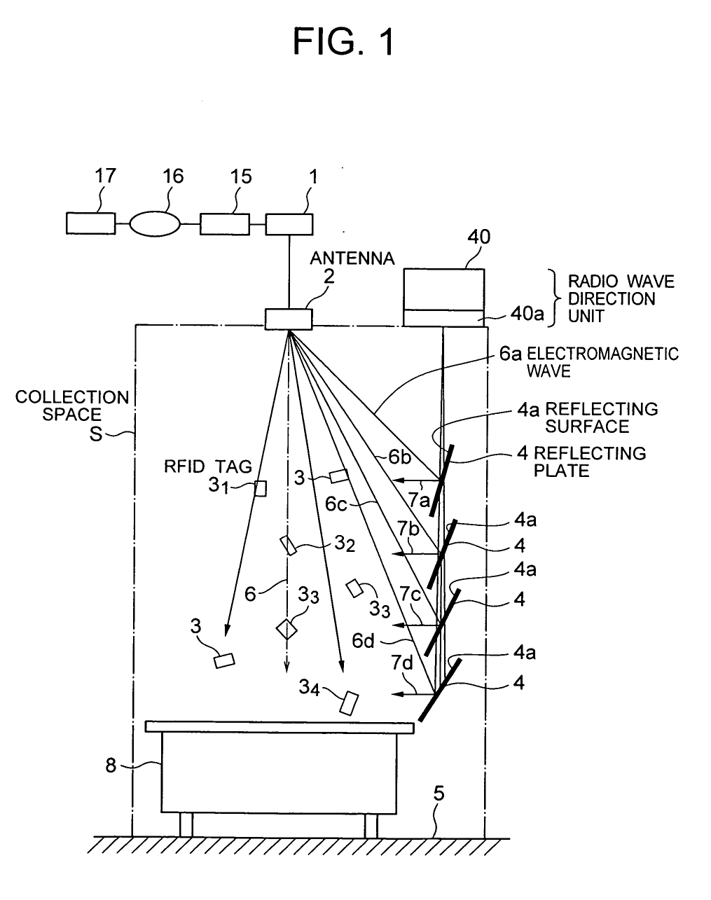

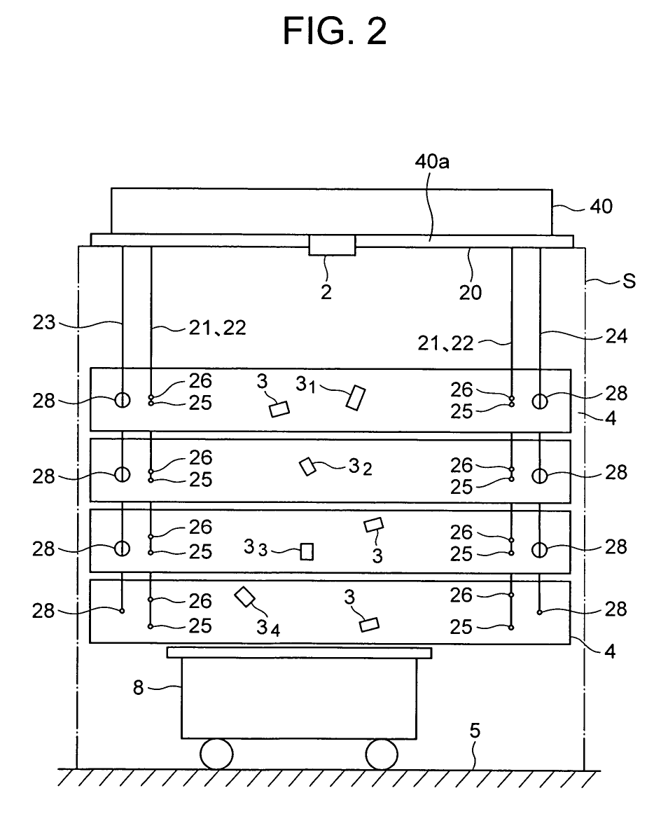

FIGS. 1 and 2 show an embodiment 1 of the present invention. As shown in FIGS. 1 and 2, articles to which the RFID tags 3 are attached and the like are piled up on a dolly 8 and are collected at a fixed position 5 in a collection space S. The collection space S may be a store or a warehouse in a distribution process, or may be a passage of a store or a part passing a production line. Namely, the collection space S means a space in which a plurality of RFID tags 3 attached to articles or the like are collected. In FIG. 1, articles to which the RFID tags 3 are attached are not shown, and only the RFID tags 3 attached to articles on the dolly 8 are shown.

On the upper part of the collection space S, that is, on the ceiling of a factory for example, the antenna 2 of the reader/writer 1 is provided downward such that the traveling direction 6 of radio waves runs toward the collection space S, so that the radio wave from the antenna 2 covers the almost whole area of the collection space S. Note that arrow lines drawn from the antenna 2 of the reader/writer 1 show radio waves and their radiated directions. The reference numeral 6 is used to show the traveling direction of the radio waves collectively, and the reference numerals 6a, 6b, 6c and 6d show radio waves actually radiated from the antenna 2, and the arrows thereof show radiating directions of the radio waves.

The reader/writer 1 is connected with a computer terminal 15, and information is exchanged between the reader/writer 1 and the computer terminal 15. Further, the computer terminal 15 is connected with a server 17 over a network 16. Information from the computer terminal 15 is collected in the server 17, and outputted from the server 17 to the computer terminal 15 over the network 16. The server 17 makes the information inputted from the reader/writer 1 into a database, and maintains the information so as to be usable in goods management of a store, production management of a factory and the like.

The reflecting plates 4 constituting the radio wave direction unit reflect radio waves from the antenna 2 of the reader/writer 1 and advance them toward the RFID tags 3 in the collection space S. Each of the reflecting plates 4 is so configured that the a reflecting surface 4a is formed on a surface to which an electromagnetic wave is made incident by metal finishing or applying an electromagnetic-reflecting agent so as to reflect the radio wave at the reflecting surface 4a. If the width of the reflecting plate 4 is in the same length of the wavelength of a radio wave (electromagnetic wave) or a length of 3/4 or 2/1 of the wavelength, resonance phenomenon of the electromagnetic wave is caused on the reflecting surface 4a and attenuated, whereby the power of the reflected wave is lowered. Therefore, the width of the reflecting plate 4 is set to be not less than the wavelength of the electromagnetic wave.

Further, the reflecting surface 4a of the reflecting plate 4 is formed in a shape of plane, two-dimensional parabolic face, cylindrical face, elliptical face or the like. If the shape of the reflecting surface 4a is a two-dimensional parabolic face, a cylindrical face, an elliptical face or the like, it is possible to suppress diffusion of the reflected wave from the reflecting surface 4a at minimum, compared with a reflecting surface 4a of a plane shape. Further, if the reflecting surface 4a is a two-dimensional parabolic face dished inward, a reflected wave shows a parallel irradiation characteristic. If the reflecting surface 4a is a cylindrical face or an elliptical face dented inward, the reflected wave shows a condensing irradiation characteristic. The reflecting surface 4a may be in a shape of two-dimensional parabolic face, cylindrical face, elliptical face or the like protruded outward, depending on the cases.

Now, the relationship between the reader/writer 1 and the RFID tag 3 will be explained. The radio waves 6a, 6b, 6c and 6d outputted from the antenna 2 of the reader/writer 1 are assumed to be radiated with an almost fan-like directional characteristic. In this case, due to the positional relationships between the radio waves 6a, 6b, 6c and 6d and the antennas of the RFID tags 3, there is a case where the antennas of the RFID tags 3 cannot receive the radio waves.

Specifically, since the antennas of the RFID tags 3 are postured appropriate for receiving the radio waves from the antenna 2 of the reader/writer 1 in FIG. 1, the RFID tags 3 are in a state capable of receiving the radio wave from the reader/writer 1 directly. On the other hand, since the RFID tags 31, 32, 33 and 34 are postured such that the antennas thereof are in parallel with the traveling directions of the radio waves from the antenna 2 of the reader/writer 1 or in a state where the radio waves are shielded by the RFID tag bodies, they cannot receive the radio waves from the antenna 2 of the reader/writer 1 with the antennas in good conditions.

In view of the above, in the present embodiment, the radio wave reflecting surface of the radio wave direction unit are arranged so as to be able to be developed facing the collection space S where the RFID tags 3 are collected, when information is transmitted and received between the RFID tags 3 and the reader/writer 1. Namely, as shown in FIGS. 1 and 2, the radio wave direction unit includes a plurality of reflecting plates 4, and the radio wave reflecting surface of the radio wave direction unit is formed of a combination of the reflecting surfaces 4a of the reflecting plates 4. The reflecting plates 4 are linked so as to enable the reflecting surfaces 4a to be developed to face the collection space S.

Next, a specific example of the radio wave direction unit will be described. As shown in FIGS. 1 and 2, a fixing unit 40 is mounted on a ceiling of a building or the like, and a beam 40a almost equal to the lateral width of the collection space S is disposed laterally on the lower surface of the fixing unit 40, and pairs of linking ropes 21 and 22 and collecting ropes 23 are hanged from an end part of the beam 40a. The collecting ropes 23 are adapted to be reeled or unreeled by a winch, not shown, of the fixing unit 40a. Note that although the reflecting plates 4 are linked by pairs of linking ropes 21 and 22, the present invention is not limited to this configuration. If the reflecting plates 4 are long, the number of linking ropes may be increased so as to be used for linkage.

The reflecting plate 4 is formed in a rectangle shape, and used in a horizontally long direction. In the reflecting plate 4, linking holes 25 and 26 are formed in end parts thereof. The reflecting plates 4 are fixed with distances to the ropes 21 and 22 put through the linking holes 25 and 26, and are linked to each other by the two ropes 21 and 22. The ends of the lowest parts of the ropes 21 and 22 are tied to the reflecting plate 4 of the lowest stage. The number of reflecting plates 4 linked by the two ropes 21 and 22 changes depending on the piling height of the RFID tags 3 piled up on the dolly 8. For example, if the width of the reflecting plate 4 is narrow, the number of linked reflecting plates 4 increases, and if the piling height of the RFID tags 3 piled up on the dolly 8 is high, the number of linked reflecting plates 4 increases.

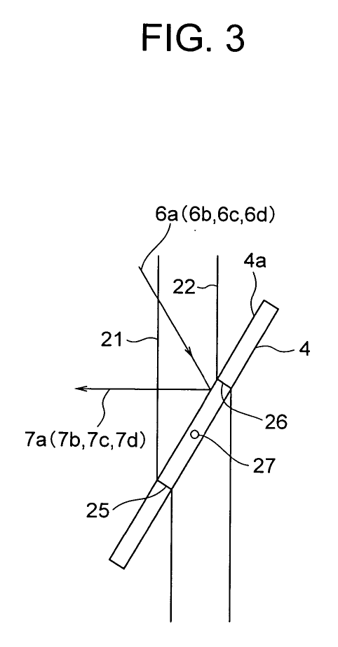

Relationships between the linking holes 25 and 25 of the reflecting plate 4 and the ropes 21 and 22 will be described specifically. As shown in FIG. 3, the linking holes 25 and 26 of the reflecting plate 4 are formed at positions symmetry in a width direction over the center axis 27 at the center in the width direction (up and down direction in FIG. 3). The reflecting plate 4 is fixed such that the fixing positions to the ropes 21 and 22 put through the linking holes 25 and 26 are shifted in up and down direction in a posture that the reflecting surface 4a thereof is tilted, that is, in a posture to reflect the radio wave 6a (6b, 6c, 6d) from the antenna 2 and advance the reflected wave 7a (7b, 7c, 7d) toward the RFID tag 3₁ (3₂, 3₃, 3₄) in the collection space S.

As shown in FIG. 3, the reflecting plates 4 are fixed to the ropes 21 and 22 in tilted postures respectively, and as shown in FIGS. 1 and 2, they are linked by the ropes 21 and 22 so as to be developed in a plurality of stages in the up and down direction hanged from the fixing unit 40. Therefore, the reflecting plates 4 are developed in a plurality of stages in the up and down direction such that the reflecting surfaces 4a face the collection space S.

When the reflecting plates 4 are developed in multiple stages in the up and down direction, the reflecting plates 4 of the respective stages must have different tilt angles for reflecting radio waves from the antenna 2 toward the collection space S, as obvious from FIG. 1. Therefore, the height positions that the reflecting plate 4 is fixed to the two ropes 21 and 22 are shifted in the up and down direction as shown in FIG. 3, whereby tilt angles of the reflecting plates 4 differ from one another.

The tilt angle of the reflecting plate 4 is changed corresponding to the position where a radio wave from the antenna 2 is made incident. In the example shown, tilt angles of the reflecting plates for reflecting the radio waves 7a and 7b toward the RFID tags 3₁ and 3₂ positioned at the upper stage to the middle stage are set to small, and tilt angles of the reflecting plates 4 for reflecting the radio waves 7c and 7d toward the RFIF tags 3₃ and 3₄ positioned at the middle stage to the lower stage are set to large. Note that the arranging number and tilt angels of the reflecting plates 4 are just an example. They may be selected appropriately by taking statistics relating to directions of antennas of the RFID tags collected in the collection space S or according to the empirical rules. In other words, it is only necessary to have a configuration in which radio waves from the antenna 2 of the reader/writer 1 can arrive at the antennas of the all RFID tags 3 collected in the collection space S by using the reflecting plates 4 having the reflecting surfaces 4a, irrespective of the directions of the antennas of the RFID tags 3.

Although the reflecting plates 4 are fixed to the two ropes 21 and 22 in a tilt manner as shown in FIG. 3, if the reeled amount or unreeled amount of the two ropes 21 and 22 are made to differ by the winch, not shown, of the fixing unit 40, the reflecting plates 4 turn in a clockwise direction or counterclockwise direction with the center axis 27 being the center, whereby the tilt angles are adjusted.

Further, as shown in FIG. 2, each of the reflecting plates 4 are provided with through holes 28 outside the positions of the linking holes 25 and 26. The two collecting ropes 23 and 24 hanged from the beam 40a are put through the through holes 28 of the reflecting plate 4 of each stage, and only the lowest end is tied to the through hole 28 of the reflecting plate 4 at the lowest stage.

Therefore, when a winch, not shown, of the fixing unit 40 starts reeling of the collecting ropes 23 and 24, first, the reflecting plate 4 of the lowest stage is drawn upward. When the reflecting plate 4 of the lowest stage contacts the reflecting plate 4 of the next upper stage, the reflecting plate 4 is drawn upward in a state of being laid on the reflecting plate 4 of the lowest stage, and the collecting operation is performed sequentially to the reflecting plates 4 of the upper stages. Thereby, the reflecting plates 4 can be collected in a state of being stacked by reeling the collecting ropes 23 and 24. In the collected state, the radio wave reflecting surface of the radio wave direction unit consisting of the reflecting surfaces 4a of the reflecting plates 4 are not developed but stored in a storing state.

The reflecting plates 4 reflect the radio waves from the antenna 2 of the reader/writer 1 made incident from a tilt direction as shown in FIG. 1 to a horizontal direction or a direction slightly deviated therefrom in an up or down direction with the tilted reflecting surfaces 4a to thereby stereoscopically advance the reflected radio waves 7a, 7b, 7c and 7d toward the collection space S.

Next, operation of the wireless communication system according to the embodiment of the present invention will be described. The RFID tag 3 is attached to an article to be identified. Then, to the RFID tag 3, information required for identifying the article is written by using an information writing device not shown. The RFID tag 3 in which the information is written is conveyed into the collection space S together with the article, and a plurality of RFID tags 3 are collected in the space S.

Articles with the RFID tags 3 are to be piled up on the dolly 8 and conveyed to the collection area 5 in the collection space S. In the process of conveying the articles into the collection space S, antenna directions of the RFID tags 3 will not be managed, so directions of the antennas face random directions actually.

In the space S where a plurality of RFID tags 3 are collected, radio waves from the main antenna 2 of the reader/writer 1 mounted on the ceiling of the space S are radiated at a timing of carrying in articles for example, and based on the radio wave, the reader/writer reads information of the RFID tags 3 to thereby manage the articles.

However, since the antennas of the RFID tags 3 face random directions as described above, it is impossible to cause the radio wave radiated from the main antenna 2 of one reader/writer 1 to be received by the antennas of the RFID tags 3 facing random directions.

In the present embodiment, the radio wave reflecting surface of the radio wave direction unit is developed to face the collection space S before the articles with the RFID tags 3 are conveyed into the collection space S by the dolly 8. That is, the collecting ropes 23 and 24 having been reeled by the winch, not shown, of the fixing unit 40 are unreeled to thereby arrange the reflecting plates 4 in multiple stages in the up and down direction.

When the reflecting plates 4 are arranged in multiple stages in the up and down direction, the reflecting plates 4 are fixed to the ropes 21 and 22 in postures in which the reflecting surfaces 4a thereof are tilted. Therefore, the radio wave reflecting surface of the radio wave direction unit formed of the reflecting surfaces 4a are developed from the stored state to postures facing the collection space S.

Therefore, to the RFID tags 3 in states of receiving the radio waves radiated from the antenna 2 of the reader/writer 1, the radio waves from the reader/writer 1 reach directly, and bidirectional communications are performed by the radio waves using the antennas of the RFID tags 3 and the antenna 2 of the reader/writer 1. Thereby, the information written in the RFID tags 3 is collected by the reader/writer 1, and is transmitted to the computer terminal 15. The computer terminal 15 provides the information obtained from the reader/writer 1 to the server 17 over the network 16. Based on the information provided from the computer terminal 15, the server 17 manages the articles to which the RFID tags 3 are attached. When the information of article management must be changed or new information must be added, the server 17 transmits the information to the computer terminal 15 over the network 16.

When the computer terminal 15 receives information from the server 17, it transmits the information to the reader/writer 1. The reader/writer 1 radiates the received information by radio waves from the antenna 2 to the space S. If the corresponding RFID tags 3 directly receive the information from the reader/writer 1 from the antenna 2, the information is written on the memories of the corresponding RFID tags 3.

If the antennas of the RFID tags 3 are not in postures of receiving the radio waves from the antenna 2 of the reader/writer 1, the radio waves from the antenna 2 of the reader/writer 1 will arrive at the RFID tags 3₁, 3₂, 3₃ and 3₄ by means of the reflecting surfaces 4a of the reflecting plates 4 as shown in FIGS. 1 and 2.

That is, there is a case where the RFID tags 3₁, 3₂, 3₃ and 3₄ in which antenna directions thereof are not aligned with respect to the radio waves from the antenna 2 of the reader/writer 1 exist, as shown in FIG. 1.

As shown in FIG. 1, the reflecting plates 4 are disposed such that the reflecting surfaces 4a are tilted to enable the radio waves to be made incident thereon, and the tilt angles of the reflecting plates 4 are changed corresponding to positions where the radio waves from the antenna 2 made incident. Therefore, when viewed from the side surface (vertical direction) side of the reflecting plates 4 arranged as shown in FIG. 1, in the respective reflecting plates arranged in multiple stages in the vertical direction, the radio waves 7a, 7b, 7c and 7d extending from the radio wave traveling direction 6 among radio waves radiated from the antenna 2 of the reader/writer 1 are made incident on the reflecting surfaces 4a of the reflecting plates 4, and are reflected stereoscopically in an obliquely upward direction, an obliquely downward direction, a horizontal direction or directions slightly deviated therefrom.

Further, when the reflecting plates 4 disposed are viewed from the above, radio waves from the reader/writer 1 are reflected so as to diffuse in a lateral direction from the reflecting plates 4.

As described above, a part of the radio waves radiated from the antenna 2 of the reader/writer 1 travels stereoscopically toward the space S by means of an action of the reflecting surfaces 4a. Further, the radio waves traveling in the same direction among the reflected waves by the reflecting plates 4 can make attenuation caused due to distance as small as possible by the synergic effect.

The radio waves 7a and 7b radiated from the reader/writer 1 shown in FIG. 1 are reflected at the reflecting surfaces 4a of the reflecting plates 4 positioned in the upper stage to the middle stage where tilt angles are small and travel reflectively toward the RFID tags 3₁ and 3₂ positioned in the upper stage to the middle stage. Therefore, it is possible to securely make the radio waves from the reader/writer 1 to arrive at the RFID tags 3₁ and 3₂ facing misaligned directions with respect to the radio waves from the reader/writer 1.

Further, the radio waves 7c and 7d radiated from the reader/writer 1 shown in FIG. 1 are reflected at the reflecting surfaces 4a of the reflecting plates 4 positioned in the middle stage to the lower stage where the tilt angles are large to thereby travel reflectively toward the RFID tags 3₃ and 3₄ positioned in the middle stage to the lower stage. Therefore, it is possible to securely make the radio waves from the reader/writer 1 to the RFID tags 3₃ and 3₄ facing misaligned directions with respect to the radio waves from the reader/writer 1.

Reflection at the reflecting plates 4 described above enables the radio waves from the reader/writer 1 to diffuse in a lateral direction by the reflecting surfaces 4a of the reflecting plates 4, and also enables the radio waves from the reader/writer 1 to arrive at antennas of all RFID tags 3 collected in the space S, irrespective of the antenna directions of the RFID tags 3 positioned in the space S.

When the article management using the RFID tags 3 ends, the radio wave direction unit arranged in the collection space S is not needed any more, and the radio wave direction unit may cause a problem in carrying the articles in and out by the dolly 8.

In the present embodiment, when the article management using the RFID tags 3 ends, the collecting ropes 23 and 24 supporting the reflecting plates 4 in the up and down direction are reeled by a winch, not shown, of the fixing unit 40.

When the winch of the fixing unit 40 starts reeling of the collecting ropes 23 and 24, first, the reflecting plate 4 of the lowest stage is drawn up and contacts the reflecting plate 4 of the next stage. When the collecting ropes 23 and 24 are reeled further, the reflecting plate 4 of the next stage is drawn up in the state of being laid on the reflecting plate 4 of the lowest stage. The collecting operation is performed sequentially to the reflecting plates 4 of the upper stages. Thereby, it is possible to store the reflecting plates 4 in a stacked state by reeling the collecting ropes 23 and 24. In the storing state, the radio wave reflecting surface of the radio wave direction unit consisting of the reflecting surfaces 4a of the reflecting plates 4 are not being developed but being stored.

(Embodiment 2)

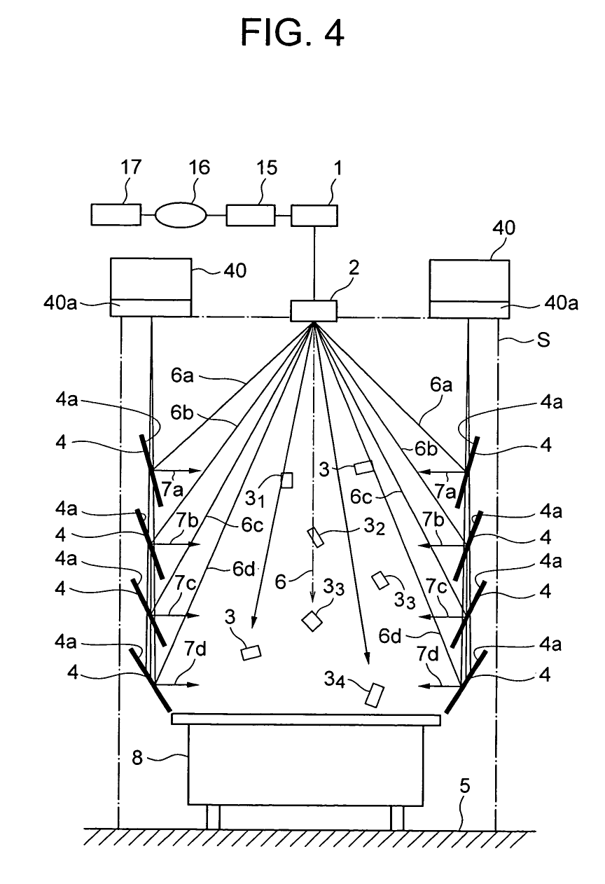

FIG. 4 shows an embodiment 2 of the present invention. As shown in FIG. 1, it is possible to reflect radio waves from the antenna 2 toward RFID tags 3 by developing the radio wave reflecting surface of the radio wave direction unit in the collection space S, in particular, on one side of the collection area 5. However, depending on the postures of the RFID tags 3, there is a case where the radio wave reflecting surface of the radio wave direction unit is desirably developed at multiple positions in the collection area 5 within the collection space S. This case will be explained as an embodiment 2 of the present invention.

As shown in FIG. 4, in the case where articles with the RFID tags 3 are piled up on the dolly 8 and are conveyed to the collection area 5 in the collection space S, the radio wave reflecting surfaces of the radio wave direction unit are developed in the right and left of the collection area 5, in the present embodiment.

The radio wave direction unit shown in FIG. 4 consists of a plurality of reflecting plates 4 same as that of the embodiment 1 shown in FIG. 1, and the radio wave reflecting surface is formed of a combination of reflecting surfaces 4a. Further, the plurality of reflecting plates 4 are linked so as to enable the reflecting surfaces 4a to be developed to face the collection space S. These configurations are same as those shown in FIGS. 1 and 2.

According to the embodiment 2 of the present invention shown in FIG. 4, when the dolly 8 mounting articles is carried into the collection area 5, the radio wave reflecting surfaces of the radio wave direction unit are developed on the right and left sides of the collection area 5. Therefore, the radio waves from the antenna 2 are reflected stereoscopically at the radio wave reflecting surfaces of the radio wave direction unit developed in the right and left sides of the collection area toward the RFID tags 3 on the dolly 8.

Therefore, exchange of radio waves between the RFID tags 3 positioned in an area where radio waves from the antenna 2 will not easily reach and the antenna 2 is performed with the radio wave reflecting surfaces of the radio wave direction unit developed on the right and left sides of the correction area 5. Thereby, radio wave conditions in transmission and reception performed between all RFID tags 3 on the dolly 8 and the antenna 2 are improved. This provides such an advantage that articles on the dolly 8 can be managed securely.

Although the radio wave reflecting surfaces of the radio wave direction unit are developed on the right and left sides of the collection area 5 in the example shown in FIG. 4, the present invention is not limited to this configuration. For example, radio wave reflecting surfaces of the radio wave direction unit may be developed at positions surrounding the collection space S. In other words, the radio wave reflecting surfaces of the radio wave direction unit may be arranged in any way provided that they are configured to be developed at a plurality of positions in the collection space S.

(Embodiment 3)

In above-described embodiments, the developed radio wave reflecting surfaces of the radio wave direction unit are stored in a folded state. However, if it is possible to evacuate the radio wave reflecting surfaces from the collection space S while the radio wave reflecting surfaces of the radio wave direction unit remain developed, the usability of the wireless system can be improved. This case will be explained as an embodiment 3 of the present invention.

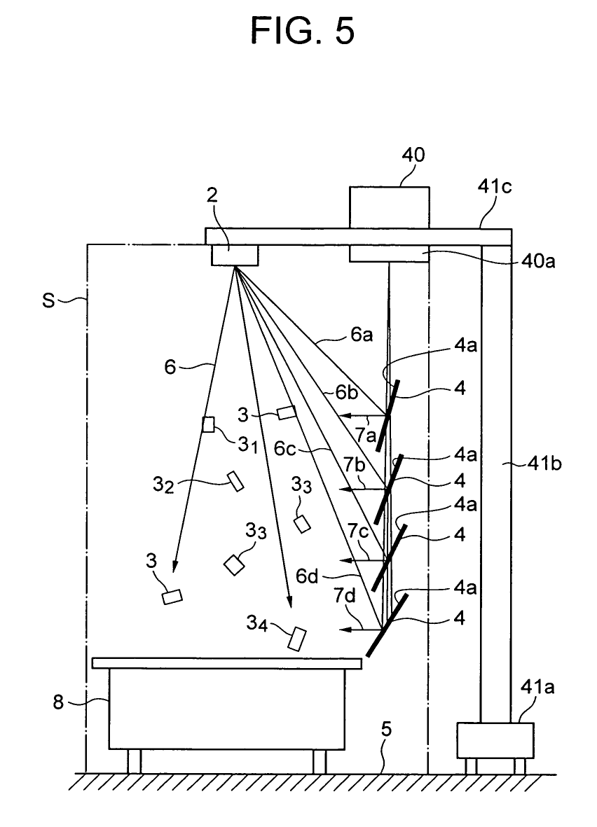

As shown in FIG. 5, the present embodiment is so configured that a radio wave direction unit is supported by a movable unit such that the radio wave reflecting surface is developed toward the collection space S. Further, in addition to the radio wave direction unit, the movable unit also supports the antenna 2 of the reader/writer 1, and is configured to move within the collection space S and is capable of evacuating to the outside of the collection space S.

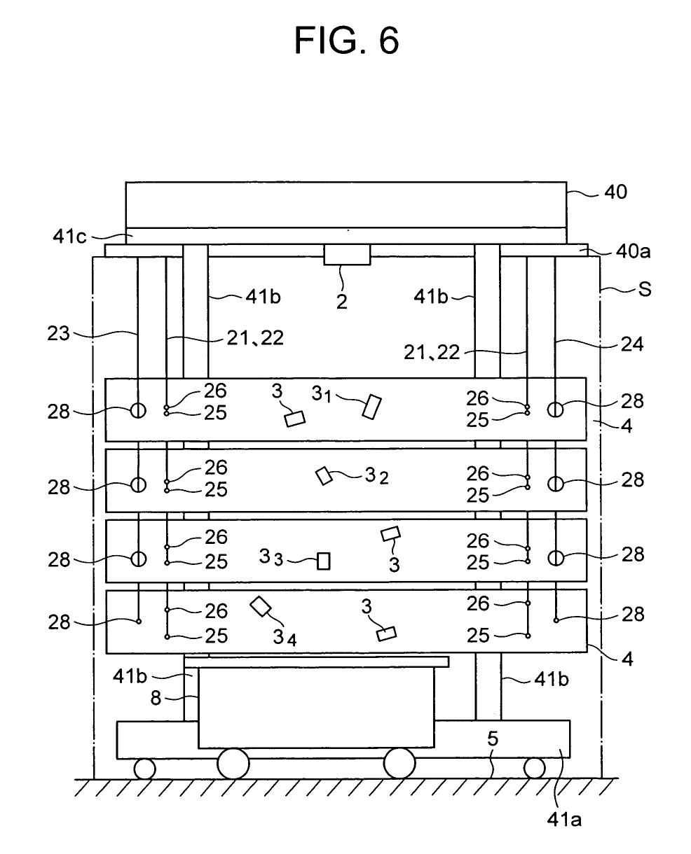

More specifically, the movable unit includes a movable dolly 41a, columns 41b, and a top plate 41c as shown in FIGS. 5 and 6. The movable dolly 4 1a is configured to move within the collection space S and to be movable to the outside of the collection space S for evacuation.

The two columns 41b are planted vertically on the movable dolly 41a, and the top plate 41c is mounted on the top parts of the columns 41b so as to cover the upper part of the collection space S. On the lower surface of the top plate 41c, a beam 40a of the fixing unit 40 is supported. Further, in the example shown, the antenna 2 is mounted on the lower surface of the top plate 41c. The antenna 2 may be mounted on the ceiling of a building or the like as required. Note that the configuration in which the radio wave direction unit shown in FIGS. 5 and 6 consists of a plurality of reflecting plates 4 and the radio wave reflecting surface of the radio wave direction unit is formed of a combination of a plurality of reflecting surfaces 4a of the reflecting plates 4 is same as that shown in FIGS. 1 and 2.

Therefore, with the radio wave reflecting surfaces of the radio wave direction unit being developed, the movable dolly 41a is moved toward the collection space S and the radio wave reflecting surface of the radio wave direction unit is arranged toward the collection space S. Further, when the article management using the RFID tags 3 ends, the movable dolly 41a is evacuated to the outside of the collection space S with the radio wave reflecting surface of the radio wave direction unit being developed. Thereby, it is possible to prevent the radio wave direction unit from causing troubles in carrying the articles in and out.

In the present embodiment, the movable dolly 41a can move in the collection area 5 of the collection space S, so a use mode described below may be taken. That is, conveying lines for conveying the dollies 8 are set in parallel in the collection area 5 of the collection space S, and dollies 8 are conveyed through a plurality of conveying lines with a time-division control with time lags. Then, the movable dolly 41a is moved to a position close to the dolly 8 conveyed through the conveying line, and the radio wave reflecting surface of the radio wave direction unit is arranged close to the RFID tags 3 on the dolly 8 to thereby perform transmission and reception of information between the RFID tags 3 and the antenna 2.

Since the dollies 8 are conveyed through a plurality of conveying lines with time lags, a series of operations such as movement of the movable dolly 41a, arranging the radio wave reflecting surface of the radio wave direction unit close to the RFID tags on the dolly 8 and transmitting and receiving information between the RFID tags 3 and the antenna 2, are carried out for each dolly 8 conveyed.

According to this use mode, it is possible to develop the radio wave reflecting surface of the radio wave direction unit for each dolly 8 on each conveying line by moving one movable dolly 41a. This enables to reduce the cost of equipment.

(Embodiment 4) As shown in FIG. 5, by developing the radio wave reflecting surface of the radio wave direction unit on one side of the collection space S, radio waves from the antenna 2 can be reflected toward the RFID tags 3. However, it may be desirable that radio wave reflecting surfaces of the radio wave direction unit be developed at a plurality of positions in the collection space S, depending on the postures of the RFID tags 3. This case will be described as an embodiment 4.

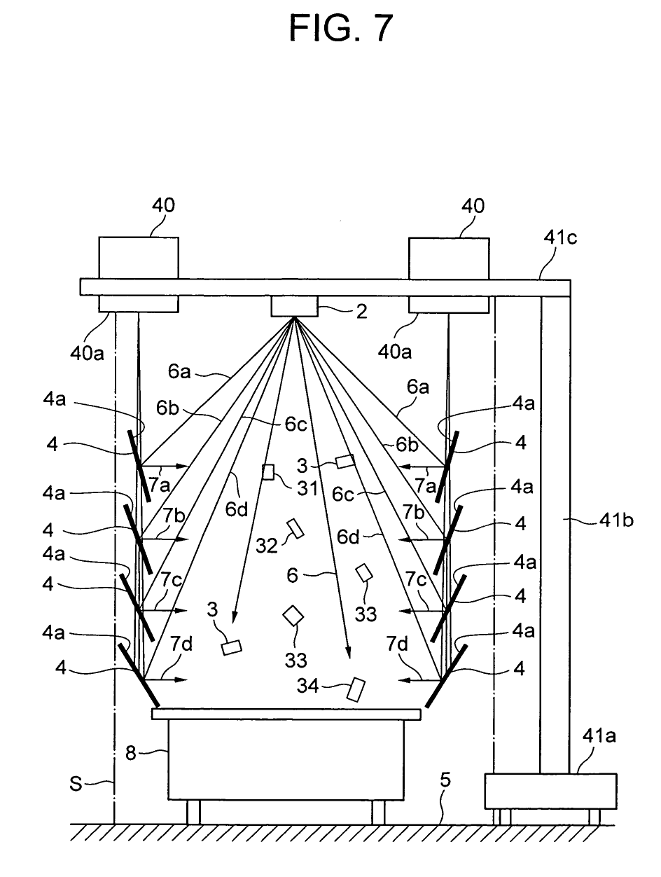

As shown in FIG. 7, the embodiment 4 of the present invention is so configured that articles with the RFID tags 3 are piled up on the dolly 8, and when it is conveyed in one direction in the collection space S, the radio wave reflecting surfaces of the radio wave direction unit are developed on the right and left sides of the conveying path 5.

The radio wave direction unit shown in FIG. 7 consists of a plurality of reflecting plates 4 same as that of the embodiment 1 shown in FIG. 1, and a plurality of reflecting surfaces 4a thereof forms the radio wave reflecting surface. Further, the reflecting plates 4 are linked so as to enable the reflecting surfaces 4a thereof to be developed to face the collection space S. These configurations are same as those shown in FIGS. 1 and 2.

Therefore, since the radio wave reflecting surfaces of the radio wave direction unit are developed on the right and left sides of the conveying path 5 for dollies according to the embodiment 4 of the present invention, radio waves from the antenna 2 are reflected stereoscopically at the radio wave reflecting surfaces on the right and left sides toward the RFID tags 3 on the dolly 8. Therefore, exchange of radio waves, between RFID tags positioned in areas where radio waves from the antenna 2 will not reach easily and the antenna 2, is performed on the radio wave reflecting surfaces of the radio wave direction unit. Thereby, the radio wave conditions in transmission and reception performed between all RFID tags 3 on the dolly 8 and the antenna 2 can be improved. This provides an advantage that management of the articles on the dolly 8 can be performed securely.

Although the radio wave reflecting surfaces of the radio wave direction unit are developed on the right and left side of the conveying path 5 of the dolly 8 in the example shown in FIG. 7, the present invention is not limited to this configuration. For example, the radio wave reflecting surfaces of the radio wave direction unit may be developed in all directions surrounding the collection space S. In other words, it is only necessary to develop the radio wave reflecting surfaces of the radio wave direction unit at a plurality of positions in the collection space S.

Although the present invention is applied to article management in the embodiments described above, the present invention is not limited to this configuration. Wireless IC chips (e.g., RFID tags) may be attached to articles, members or devices to be moved through belt conveyers or by dollies so as to manage them. Further, wireless IC chips (e.g., RFID tags) may be attached to articles, members or devices stored in a factory, a warehouse or a distribution channel so as to manage them. Moreover, wireless IC chips (e.g., RFID tags) may be held by or attached to humans or animals to thereby apply the present invention in recognizing the humans or individuals, or in managing entrance and exit.

As described above, according to the present invention, radio waves from a reader/writer are reflected toward RFID tags by using reflecting plates, whereby it is possible to perform communications of high reliability with RFID tags by using radio waves directly radiated from the reader/writer and radio waves reflected at the reflecting plates.

What is claimes is:

1. A wireless communication system comprising:
a wireless IC chip provided to an identification object;
a transceiver for transmitting and receiving information to/from the wireless IC chip by a radio wave; and
a radio wave direction unit for directing a traveling direction of a radio wave from the transceiver toward the wireless IC chip, wherein
the radio wave direction unit is arranged such that a radio wave reflecting surface can be developed to face a collection space where a plurality of wireless IC chips are collected.

2. The wireless communication system, as claimed in claim 1, wherein the radio wave direction unit includes a plurality of reflecting plates, and
the radio wave reflecting surface of the radio wave direction unit is formed of a combination of reflecting surfaces of the reflecting plates.

3. The wireless communication system, as claimed in claim 2, wherein the plurality of reflecting plates are linked so as to enable the reflecting surfaces to be developed to face the collection space.

4. The wireless communication system, as claimed in claim 3, wherein the reflecting surfaces of the plurality of reflecting plates face different directions with respect to the transceiver, depending on developed positions.

5. The wireless communication system, as claimed in claim 4, wherein directions of the reflecting plates are adjustable.

6. The wireless communication system, as claimed in claim 1, wherein the radio wave direction unit is so configured that the radio wave reflecting surfaces are developed at a plurality of positions in the collection space.

7. The wireless communication system, as claimed in claim 1, wherein the radio wave direction unit is so configured that the radio wave reflecting surface is developed by being supported by a movable unit.

8. The wireless communication system, as claimed in claim 7, wherein the movable unit is arranged to be able to evacuate to an outside of the collection space.

9. The wireless communication system, as claimed in claim 1, wherein an antenna of the transceiver and the radio wave direction unit are supported by a movable unit.

10. The wireless communication system, as claimed in claim 7, wherein the movable unit moves inside the collection unit and is also able to evacuate to an outside of the collection space.
